(19) United States
(12) Patent Application Publication
(10) Pub. No.: US 2026/0267465 A1
(43) Pub. Date: Sep. 10, 2026

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventor: Minami NAKA, Osaka (JP)

(73) Assignee: PANASONIC INTELLECTUAL PROPERTY MANAGEMENT CO., LTD., Osaka (JP)

(21) Appl. No.: 19/661,295

(22) Filed: Apr. 28, 2026

Related U.S. Application Data
(63) Continuation of application No. PCT/JP2024/038602, filed on Oct. 30, 2024.
(60) Provisional application No. 63/547,011, filed on Nov. 2, 2023.

(30) Foreign Application Priority Data
Sep. 11, 2024 (JP) 2024-157609

(51) Int. Cl. G06F 3/04817; G06F 16/43

(52) U.S. Cl. CPC G06F 3/04817; G06F 16/43

(57) ABSTRACT

An information processing method includes: displaying a bird’s-eye view on a display of a terminal device; displaying, in the bird’s-eye view, a plurality of image capture point icons that indicate image capture points, each of the image capture point icons being associated with stored text information; receiving, via a search window displayed on the display, input of a keyword from a user; searching the stored text information associated with the image capture point icons for text information including the keyword; identifying, based on the searching, at least one first icon from among the image capture point icons, each identified first icon being associated with text information including the keyword; and displaying the at least one first icon in an emphasized manner by changing a display mode of the at least one first icon relative to a display mode of an icon associated with text information not including the keyword.

### FIELD OF INVENTION

The present disclosure relates to a technique for remotely checking the situation of a site.

### BACKGROUND ART

The technique of Patent Literature 1 discloses a captured image management system. This system includes an image input unit, an image capture location designation unit, and a captured image display unit. The image input unit receives an input of a captured image obtained by capturing an image of a site. The image capture location designation unit displays a floor map on a screen. The image capture location designation unit receives, as the image capture location of the captured image, the position clicked on the floor map. The image capture location designation unit displays, on the floor map, a marker indicating the image capture location. The captured image display unit displays, on the screen, the captured image corresponding to the image capture location indicated by the marker selected by a user. The captured image display unit displays an icon superimposed on the captured image. In response to selection of the icon by the user, the captured image display unit displays related documents, such as a description and a detailed drawing, regarding an object captured in the captured image.

With the technique disclosed in Patent Literature 1, the number of processing steps executed by a computer increases in order to check an image capture point icon linked with desired text information, resulting in an increase in a load on the computer.

Patent Literature 1: JP 6908953 B1

### SUMMARY OF THE INVENTION

The present disclosure has been made to solve such a problem, and an object thereof is to provide a technique capable of suppressing an increase in a load on a computer.

An information processing method according to one aspect of the present disclosure is an information processing method in a computer, the method including: displaying a bird’s-eye view on a display of a terminal device; displaying, in the bird’s-eye view, a plurality of image capture point icons that indicate image capture points, each of the plurality of image capture point icons being associated with stored text information; receiving, via a search window displayed on the display, input of a keyword from a user; searching the stored text information associated with the plurality of image capture point icons for text information including the keyword; identifying, based on the searching, at least one first icon from among the plurality of image capture point icons, each identified first icon being associated with text information including the keyword; and displaying the at least one first icon in an emphasized manner by changing a display mode of the at least one first icon relative to a display mode of an icon associated with text information not including the keyword.

According to the present disclosure, it is possible to allow the user to easily grasp the location of the image capture point icon that is associated with the desired text information. As a result, an increase in the number of processing steps executed by the computer is suppressed, thereby making it possible to suppress an increase in the load on the computer.

### BRIEF DESCRIPTION OF THE DRAWINGS

FIG. 1 is a block diagram illustrating an example of an overall configuration of an information processing system according to a first embodiment of the present disclosure.

FIG. 2 is a diagram illustrating an example of a display screen displayed on a display of a terminal device.

FIG. 3 is a flowchart illustrating a flow of processing executed in the information processing system according to the first embodiment.

FIG. 4 is a flowchart illustrating details of second processing in a case in which annotation information is associated with an image capture point icon.

FIG. 5 is a flowchart illustrating details of second processing in a case in which additional text information is associated with the image capture point icon.

FIG. 6 is a flowchart illustrating details of third processing illustrated in FIG. 3.

FIG. 7 is a diagram illustrating an example of a display screen displayed on a display in step S301 of FIG. 6.

FIG. 8 is a diagram illustrating an example of a display screen displayed on a display according to a first modification and a second modification.

FIG. 9 is a diagram illustrating an example of a display screen displayed on a display according to a third modification.

FIG. 10 is a diagram illustrating an example of a display screen displayed on a display according to a fourth modification.

FIG. 11 is a diagram illustrating another example of the display screen displayed on the display according to the fourth modification.

### DETAILED DESCRIPTION

### Background Leading to Aspect of Present Disclosure

As problems of a site such as a construction site, there are problems such as: specific instructions not being conveyed to workers; taking time to explain the instructions; requiring manpower to go around the entire site; and taking time to travel to the site.

To solve these problems, for example, it is conceivable that a large number of cameras are installed at the site and a remote user gives instructions to workers while referring to images obtained from the large number of cameras; however, such a method is not practical. Specifically, with the above method, as the work process at the site progresses, work occurs such as removing the installed cameras or installing the removed cameras at other places. Such work is time-consuming. Thus, installing a large number of cameras at a construction site is not practical. Accordingly, the present inventor has studied a technique for remotely checking the situation of a construction site without installing a large number of cameras at the construction site.

As a result of studies, the inventor has found that, with a user interface in which a plurality of image capture point icons are displayed in a superimposed manner on a bird’s-eye view corresponding to the site, a user can remotely check the situation of the site. In detail, the inventor has obtained a finding that, when text information indicating comments, memos, or the like of workers at the site is associated with the plurality of image capture point icons, and in response to the user selecting one of the image capture point icons, the text information associated with the selected image capture point icon is output, the user can remotely check the situation of the site.

However, in the user interface described above, in some cases, the user is required to search for an image capture point icon associated with desired text information. Specifically, when many image capture point icons are displayed on the bird’s-eye view and text information is associated with these image capture point icons, it becomes difficult for the user to grasp which image capture point icon is associated with what kind of text information. In this case, the user performs work of selecting the image capture point icons one by one, and searching for the image capture point icon associated with the desired text information. In this case, the number of processing steps executed by a computer increases, resulting in an increase in a load on the computer.

Accordingly, as a result of further studies, the present inventor has found that, if an image capture point icon associated with text information desired by the user can be explicitly indicated to the user, the above-described work of searching for the image capture point icon can be omitted, thereby making it possible to suppress an increase in the number of processing steps executed by the computer.

The present disclosure has been made based on such findings.

(1) An information processing method according to one aspect of the present disclosure is an information processing method in a computer, the method including: displaying a bird’s-eye view on a display of a terminal device; displaying, in the bird’s-eye view, a plurality of image capture point icons that indicate image capture points, each of the plurality of image capture point icons being associated with stored text information; receiving, via a search window displayed on the display, input of a keyword from a user; searching the stored text information associated with the plurality of image capture point icons for text information including the keyword; identifying, based on the searching, at least one first icon from among the plurality of image capture point icons, each identified first icon being associated with text information including the keyword; and displaying the at least one first icon in an emphasized manner by changing a display mode of the at least one first icon relative to a display mode of an icon associated with text information not including the keyword.

According to this configuration, the first icon, which is the image capture point icon associated with the text information including the keyword input by the user, is displayed in an emphasized manner. In this way, the user can easily grasp the location of the first icon that is the image capture point icon associated with the desired text information. As a result, an increase in the number of processing steps executed by the computer is suppressed, thereby making it possible to suppress an increase in the load on the computer.

(2) In the information processing method according to (1) above, the plurality of image capture point icons are associated with image information, and displaying the first icon in an emphasized manner may include displaying, on the display, image information associated with the first icon together with the first icon displayed in an emphasized manner.

According to this configuration, the image information associated with the first icon is displayed on the display together with the first icon displayed in an emphasized manner, thereby improving convenience.

(3) In the information processing method according to (1) or (2) above, displaying the first icon in an emphasized manner may include not displaying, in the bird’s-eye view, a second icon associated with text information not including the keyword among the plurality of image capture point icons.

According to this configuration, since the second icon is no longer displayed on the display, it is possible to allow the user to more reliably grasp the location of the first icon.

(4) In the information processing method according to (2) or (3) above, the image information is associated with at least one attention display that is superimposed on the image information and displayed on the display, the text information is associated with at least one of the at least one attention display, and the method further may include, when a plurality of the attention displays is associated with the image information, displaying, on the display, only the attention display associated with the text information.

According to this configuration, since only the attention display associated with the text information is displayed on the display, when a plurality of the attention displays is associated with the image information, it is possible to allow the user to more reliably understand which attention display the text information is associated with.

(5) In the information processing method according to (2) or (3) above, the image information is associated with at least one attention display that is superimposed on the image information and displayed on the display, the text information is associated with at least one of the at least one attention display, and the method further may include, when a plurality of the attention displays is associated with the image information, displaying, on the display, the attention display associated with the text information in a mode different from a mode of the attention display not associated with the text information.

According to this configuration, it is possible to make the display mode different between the attention display associated with the text information and the attention display not associated with the text information. In this way, when a plurality of the attention displays is associated with the image information, it is possible to allow the user to more reliably understand which attention display the text information is associated with.

(6) In the information processing method according to (4) or (5) above, displaying, in the bird’s-eye view, the plurality of image capture point icons may include making display modes of the image capture point icons different between a case in which the text information is associated with the attention display and a case in which the text information is not associated with the attention display.

According to this configuration, it is possible to present the image capture point icons to the user in a manner that allows the user to distinguish between the image capture point icons for which the text information is associated with the attention display and the image capture point icons for which the text information is not associated with the attention display.

(7) The information processing method according to any one of (1) to (6) above, further includes receiving an input of a narrowing-down condition, wherein displaying the first icon in an emphasized manner may include displaying, in an emphasized manner, only a first icon that satisfies the narrowing-down condition.

According to this configuration, since only a first icon that satisfies the narrowing-down condition is displayed in an emphasized manner, the location of the first icon that satisfies a condition desired by the user can be made clear.

The present disclosure can be implemented not only as the information processing method for executing the characteristic processing as described above, but also as an information processing device or the like having a characteristic configuration corresponding to the characteristic processing executed in the information processing method. The present disclosure can also be implemented as a computer program for causing a computer to execute characteristic processing included in such an information processing method. Therefore, even other aspects below can achieve an effect as in the above information processing method.

(8) An information processing device according to another aspect of the present disclosure is an information processing device including a processor, wherein the processor executes: displaying a bird’s-eye view on a display of a terminal device; displaying, in the bird’s-eye view, a plurality of image capture point icons that indicate image capture points, each of the plurality of image capture point icons being associated with stored text information; receiving, via a search window displayed on the display, input of a keyword from a user; searching the stored text information associated with the plurality of image capture point icons for text information including the keyword; identifying, based on the searching, at least one first icon from among the plurality of image capture point icons, each identified first icon being associated with text information including the keyword; and displaying the at least one first icon in an emphasized manner by changing a display mode of the at least one first icon relative to a display mode of an icon associated with text information not including the keyword.

(9) An information processing program according to yet another aspect of the present disclosure causes a computer to execute: displaying a bird’s-eye view on a display of a terminal device; displaying, in the bird’s-eye view, a plurality of image capture point icon that indicates image capture points, each of the plurality of image capture point icons being associated with stored text information; receiving, via a search window displayed on the display, input of a keyword from a user; searching the stored text information associated with the plurality of image capture point icons for text information including the keyword; identifying, based on the searching, at least one first icon from among the plurality of image capture point icons, each identified first icon being associated with text information including the keyword; and displaying the at least one first icon in an emphasized manner by changing a display mode of the at least one first icon relative to a display mode of an icon associated with text information not including the keyword.

The present disclosure can also be implemented as an information processing system that operates on such an information processing program. In addition, it is needless to say that such a program can be distributed via a computer-readable non-transitory recording medium such as a CD-ROM or via a communication network such as the Internet.

Hereinafter, embodiments of the present disclosure will be described with reference to the drawings. Note that each of the embodiments described below illustrates a specific example of the present disclosure. Numerical values, shapes, components, steps, order of steps, and the like described in the following embodiments are merely examples, and are not intended to limit the present disclosure. Furthermore, a component not described in an independent claim representing a highest concept among components in the following embodiments is described as an optional component. In all the embodiments, respective contents can be combined.

### (First Embodiment)

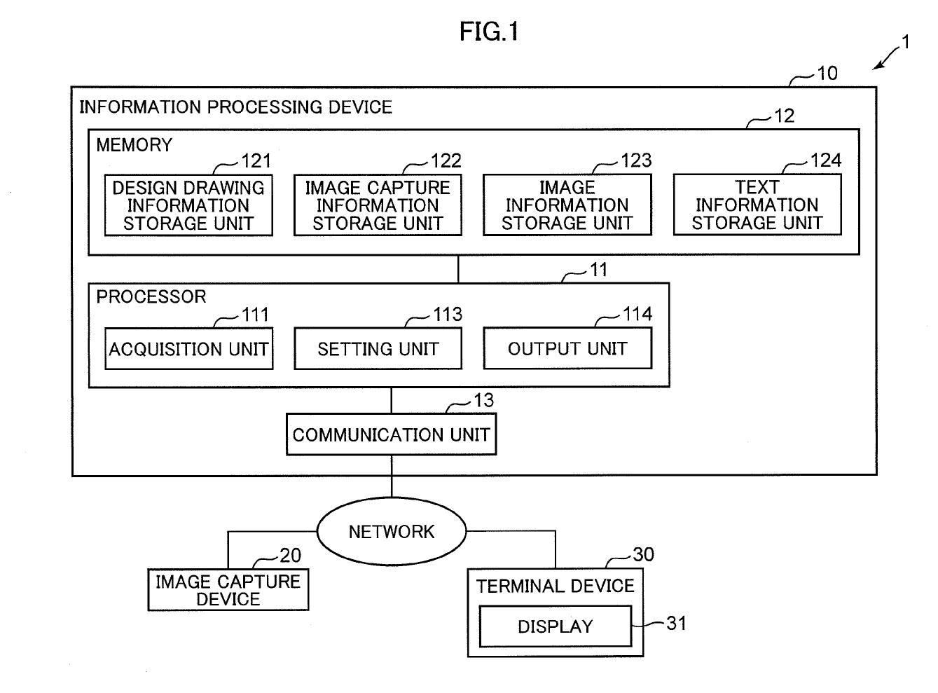

FIG. 1 is a block diagram illustrating an example of a configuration of an information processing system 1 according to a first embodiment of the present disclosure. The information processing system 1 includes an information processing device 10, an image capture device 20, and a terminal device 30. The information processing device 10, the image capture device 20, and the terminal device 30 are communicably connected via a network. An example of the network is the Internet. The information processing device 10 is, for example, a cloud server composed of one or a plurality of computers. However, this is merely an example, and the information processing device 10 may be configured by an edge server or may be implemented in the terminal device 30.

The image capture device 20 is, for example, configured by an omnidirectional camera, and captures an image at a predetermined frame rate. The image capture device 20 is, for example, a portable image capture device carried by a user. The user is, for example, a worker and a site supervisor at a site. The site is, for example, a construction site. The user moves in the construction site while capturing the image of the construction site with the image capture device 20. In detail, at an image capture start point, the user turns an image capture direction of the image capture device 20 toward a reference direction, presses an image capture button of the image capture device 20 to start an image capture operation, and when reaching an image capture end point, presses the image capture button again to end the image capture operation. The reference direction is, for example, the north direction, but is not limited thereto. The image capture device 20 transmits image information indicating the captured image to the information processing device 10 via the network. As a result, the information processing device 10 can acquire image information at a plurality of image capture points in the construction site. Here, since the image capture device 20 captures an image at a predetermined frame rate, the image capture point is defined on a frame period basis. However, this is merely an example, and the image capture point may be defined every predetermined time (e.g., 1 second, 1 minute, etc.). The image information is associated with the position of the image capture point and the image capture date and time. The position of the image capture point is acquired by, for example, a position sensor such as a magnetic sensor or a global positioning system (GPS) sensor included in the image capture device 20, and is represented by latitude and longitude. The image capture date and time is acquired by, for example, a clock included in the image capture device 20. The image capture device 20 includes an image sensor, an operation device, a communication circuit, a signal processing circuit, and the like. The image capture device 20 may be configured by a portable computer such as a smartphone or a tablet computer.

The terminal device 30 is carried by the user. The terminal device 30 may be configured by, for example, a portable computer, such as a smartphone or a tablet computer, or may be configured by a stationary computer. The terminal device 30 displays the image information on a display 31 under the control of the information processing device 10. Although one terminal device 30 is illustrated in the example of FIG. 1, a plurality of terminal devices may be connected to the information processing device 10 via the network. The terminal device 30 includes a central processing unit (CPU), a memory, the display 31, operation devices such as a touchscreen, a mouse, and a keyboard, and a communication circuit.

The information processing device 10 includes a processor 11, a memory 12, and a communication unit 13. The processor 11 is configured by, for example, a central processing unit (CPU). The processor 11 includes an acquisition unit 111, a setting unit 113, and an output unit 114. The acquisition unit 111 through the output unit 114 may be implemented by the processor 11 executing an information processing program, or may be configured by a dedicated hardware circuit such as an application-specific integrated circuit (ASIC).

The acquisition unit 111 acquires a display instruction from the terminal device 30 via the communication unit 13. The display instruction is an instruction input by the user into the terminal device 30, and is an instruction for requesting that a predetermined design drawing be displayed on the display 31. The display instruction includes a design drawing ID that is an identifier of the design drawing. The acquisition unit 111 reads, from the memory 12, the design drawing indicated by the design drawing ID. The design drawing is image data indicating a design drawing of a site. The design drawing is an example of a bird’s-eye view. The acquisition unit 111 may acquire a plan view, a blueprint, a map, or a perspective view of the construction site instead of the design drawing. The plan view, the blueprint, the map, and the perspective view are other examples of the bird’s-eye view. The design drawing is associated in advance with latitude and longitude at positions serving as key points. The positions serving as key points are, for example, positions of four corners in the design drawing.

Furthermore, the acquisition unit 111 acquires character information input by the user into the terminal device 30 via the communication unit 13. The acquisition unit 111 identifies, based on the character information, at least one first icon from among a plurality of image capture point icons 201. The first icon is the image capture point icon 201 associated with the text information including the character information input by the user. The acquisition unit 111 inputs the identification result of the first icon to the output unit 114. At this time, the acquisition unit 111 reads, from the memory 12, the image information associated with the first icon and inputs the image information to the output unit 114.

In addition, the acquisition unit 111 acquires a selection instruction from the terminal device 30 via the communication unit 13. The selection instruction is an instruction transmitted from the terminal device 30 to the acquisition unit 111 in response to the user selecting one of the plurality of image capture point icons 201 displayed on the design drawing. When acquiring the selection instruction, the acquisition unit 111 acquires image capture information associated with the image capture point icon 201 selected by the user. The acquisition unit 111 inputs the image capture information to the output unit 114.

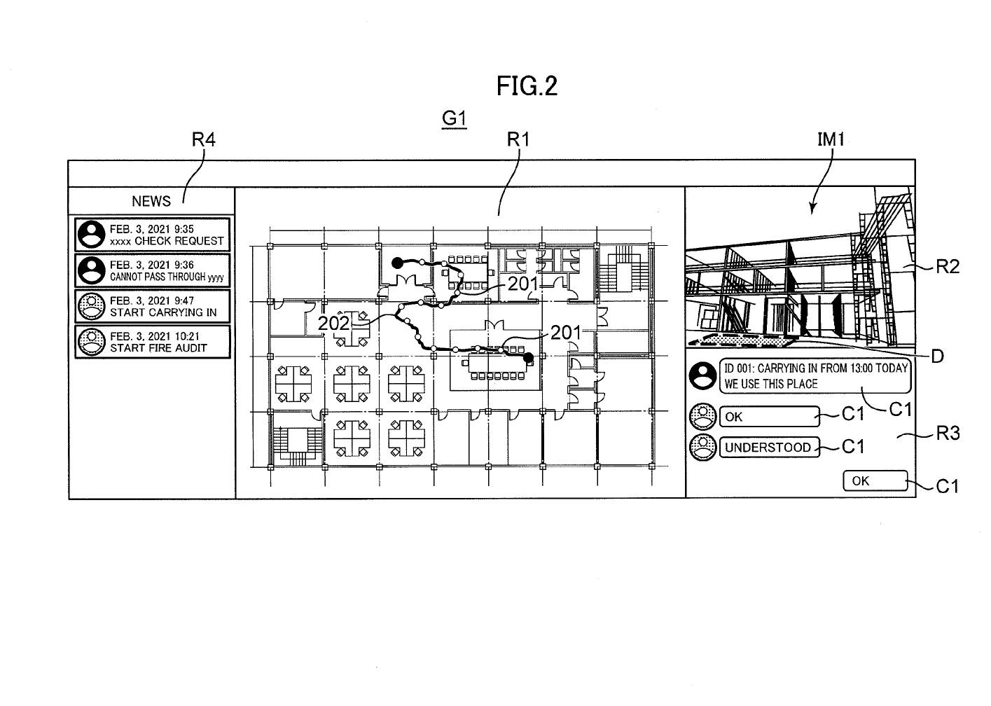

The setting unit 113 determines a first display range when the image information associated with the first icon or the image information associated with the image capture point icon 201 selected by the user is displayed in an image information display field R2 (FIG. 2) to be described later. As described above, in the present embodiment, image capture using a 360-degree camera is performed. It is difficult to display the entirety of an image captured by the 360-degree camera in the image information display field R2 at one time; accordingly, the setting unit 113 determines a partial range of the entirety of the image information as the first display range. The first display range is displayed in the image information display field R2. For example, the setting unit 113 determines the first display range such that the reference direction (the north direction in this example) is located at the center of the image information display field R2. That is, the setting unit 113 determines the first display range such that the range around the reference direction is displayed in the image information display field R2. Furthermore, the setting unit 113 determines the magnification of the first display range when the first display range is displayed in the image information display field R2.

The output unit 114 generates control information including instructions for causing the display 31 to display various display screens. The output unit 114 generates control information based on various information received from the acquisition unit 111 and the setting unit 113.

FIG. 2 is a diagram illustrating an example of a display screen G1 displayed on the display 31 by the terminal device 30 that has received the control information from the output unit 114. The display screen G1 is a basic screen of an application (user interface) provided by the information processing system 1. As illustrated in FIG. 2, the display screen G1 includes a design drawing display field R1, the image information display field R2, a text information display field R3, and a news display field R4.

The design drawing display field R1 displays a design drawing. As illustrated in FIG. 2, the plurality of image capture point icons 201 and a trajectory 202 are displayed in a superimposed manner on the design drawing illustrated in the design drawing display field R1.

The plurality of image capture point icons 201 indicate image capture points of a plurality of pieces of image information captured by the image capture device 20. In this example, each of the plurality of image capture point icons 201 are configured by a circular image. Each of the plurality of image capture point icons 201 are associated with the text information and the image information.

The plurality of image capture point icons 201 are an image capture point icon group indicating a series of the plurality of image capture points from the image capture start point to the image capture end point. They include a first icon and a second icon. The first icon is the image capture point icon associated with the text information including the keyword input by the user. The second icon is the image capture point icon associated with the text information not including the keyword input by the user.

When the acquisition unit 111 identifies the first icon, the output unit 114 transmits, to the terminal device 30, control information for displaying the first icon in an emphasized manner. Details will be described later.

Furthermore, when the acquisition unit 111 acquires a selection instruction, that is, when the user selects one of the plurality of image capture point icons 201, the output unit 114 transmits, to the terminal device 30, control information for making a display mode of the image capture point icon 201 selected by the user (hereinafter referred to as a selected icon) different from the display modes of the other image capture point icons 201. For example, the output unit 114 transmits, to the terminal device 30, control information including an instruction to make the color of the selected icon different from the colors of the other image capture point icons 201.

The trajectory 202 indicates a trajectory that is the movement path of the user during capture of the image information. In this example, the trajectory 202 is configured by a line connecting adjacent image capture point icons 201. The image capture point icon 201 positioned at the leading end of the trajectory 202 and the image capture point icon 201 positioned at the trailing end of the trajectory 202 are displayed in a larger size than the other image capture point icons 201. The image capture point icon 201 positioned at the leading end (e.g., the right end in FIG. 2) of the trajectory 202 indicates an image capture start position, and the image capture point icon 201 positioned at the trailing end (e.g., the left end in FIG. 2) of the trajectory 202 indicates an image capture end position.

The image information display field R2 displays the image information associated with the image capture point icon 201. For example, when the acquisition unit 111 identifies the first icon, the image information display field R2 displays the image information associated with the first icon. Furthermore, when the user selects a predetermined image capture point icon 201, the image information display field R2 may display the image information associated with the selected icon. Note that when the processing of identifying the first icon has not been executed and the user has not selected the image capture point icon 201, the image information display field R2 may be blank.

In some cases, the image information is associated with an attention display that is superimposed on the image information and displayed on the display 31. In this case, the image information display field R2 draws the attention display in the image information. For example, a rectangular frame D is drawn in an image information IM1 displayed in the image information display field R2 in FIG. 2. The rectangular frame D is an example of the attention display. For example, in order to emphasize a predetermined object or a predetermined region appearing in the image information IM1, the rectangular frame D is added to the image information IM1 by a worker or the like at the site. That is, on the image information, in some cases, a frame such as a bounding box is displayed in a superimposed manner.

The text information display field R3 displays the text information associated with the first icon. The text information is configured by text (text string).

The text information according to the present embodiment is classified into annotation information and additional text information. The annotation information is text information associated with the rectangular frame D (attention display) in the image information. That is, when the attention display such as a bounding box is displayed in the image information display field R2, and a text string such as a memo, a comment, or a caption is linked to (associated with) the bounding box, the information processing device 10 handles such a text string as the annotation information.

In contrast, the text information that is associated with the first icon but not associated with the attention display is the additional text information. Irrespective of the attention display, in some cases, a text string such as a memo, a comment, or a caption is also associated with the first icon. For example, in some cases, a text string describing the overall characteristics of the image information associated with the first icon is associated with the first icon. For example, in some cases, a text string describing the image capture point at which the first icon is displayed is also associated with the first icon. In addition, in some cases, messages exchanged between users are associated with the first icon. The information processing device 10 handles such a text string as the additional text information.

In the example illustrated in FIG. 2, the text information display field R3 displays a list of pieces of text information C1 input by a plurality of users with respect to the image information displayed in the image information display field R2. In the text information display field R3, pieces of text information C1 input by users other than the user are displayed on the left side, and text information C1 input by the user is displayed on the right side.

As an example, when the text information is the annotation information, the output unit 114 displays an attention display ID at the beginning of the text information. The attention display ID is an identifier of the attention display. For example, as illustrated in FIG. 2, it is assumed that a certain user inputs text information “Carrying in from 13:00 today; We use this place”. At this time, it is assumed that the user inputs an operation of linking the text information to the rectangular frame D displayed in the image information display field R2. In this case, the output unit 114 acquires the attention display ID of the rectangular frame D, and appends the attention display ID to the beginning of the text information input by the user. That is, as illustrated in FIG. 2, the output unit 114 causes the text information “ID 001: Carrying in from 13:00 today; We use this place” to be displayed.

In addition, the output unit 114 may cause the attention display ID to be displayed as link text in the text information display field R3, and may, when the user clicks the attention display ID, display the attention display corresponding to the attention display ID in an emphasized manner. For example, the output unit 114 may display, in a blinking manner, the rectangular frame D in the image information display field R2.

Note that when the processing of identifying the first icon has not been executed and the user has not selected the image capture point icon 201, the text information display field R3 may be blank.

The news display field R4 displays various pieces of news regarding the site. For example, the news display field R4 displays a message or the like indicating that the text information has been associated with the predetermined image capture point icon 201.

Returning to FIG. 1, the memory 12 is configured by a nonvolatile rewritable storage device such as a hard disk drive or a solid state drive. The memory 12 includes a design drawing information storage unit 121, an image capture information storage unit 122, an image information storage unit 123, and a text information storage unit 124.

The design drawing information storage unit 121 stores at least one design drawing. The design drawing information storage unit 121 also stores a design drawing ID assigned to each design drawing. The design drawing information storage unit 121 also stores latitude and longitude of key points (e.g., four corners) of each design drawing.

The image capture information storage unit 122 stores image capture information that is information regarding a single image capture operation using the image capture device 20. The image capture information is generated each time a single image capture operation is performed. A single image capture operation refers to a series of operations from when a worker carrying the image capture device 20 starts capturing images at the site until the worker stops capturing images. A plurality of pieces of image information is generated by a single image capture operation.

The image capture information includes a design drawing ID, an image capture ID, an image capture date and time, a representative value of the image capture date and time, position information of the image capture point, and position information of the image capture point icon 201. The design drawing ID is an identifier of the design drawing of the site where the image capture operation is performed. The image capture ID is an identifier for identifying each image capture included in a single image capture operation. The image capture date and time is information indicating the year, month, day, time, and the like when the image capture indicated by the image capture ID is performed. The representative value of the image capture date and time is, for example, information indicating the year, month, day, and time at the start of the image capture. The position information of the image capture point indicates a position (latitude and longitude) at which the image capture indicated by the image capture ID is performed. The position information of the image capture point icon 201 indicates a position (coordinates) on the design drawing at which the image capture point icon 201 corresponding to the image capture indicated by the image capture ID is displayed. Note that the position on the design drawing at which the image capture point icon 201 is displayed is calculated by mapping the image capture point onto the design drawing for each image capture indicated by the image capture ID based on the latitude and longitude of the key points (four corners) of the design drawing stored in the design drawing information storage unit 121 and the position information (latitude and longitude) of the image capture point.

The image information storage unit 123 stores image information. The image information refers to a single image generated by each image capture performed in a single image capture operation. As described above, in the present embodiment, since the image capture device 20 performs image capture at a predetermined frame rate (e.g., 30 fps), a plurality of pieces of image information is stored in the image information storage unit 123. Each piece of image information stored in the image information storage unit 123 is associated with the image capture ID. Using the image capture ID as a key, the information processing device 10 can identify the image capture information associated with the image information. Furthermore, when the attention display is added to the image information, the attention display ID for identifying the attention display is associated with the image information. When a plurality of attention displays is associated with a single piece of image information, a plurality of attention display IDs is associated with the single piece of image information. In addition, when the attention display is added to the image information, the image information storage unit 123 stores attention display position information indicating the position on the image information at which the attention display is displayed. The attention display position information includes, for example, coordinate values of each vertex of the rectangular frame D on the image information.

The text information storage unit 124 stores the text information associated with each image capture point icon 201. Furthermore, each piece of text information is associated with the image capture ID. Using the image capture ID as a key, the information processing device 10 identifies the position on the design drawing at which the image capture point icon 201 associated with the text information is displayed.

In addition, the text information storage unit 124 stores category information linked to each piece of text information. The category information is information indicating whether the text information is the annotation information or the additional text information.

Furthermore, the text information storage unit 124 stores the attention display ID for identifying which attention display the annotation information is linked to. In a case in which, for example, a plurality of attention displays is added to the image information, the information processing device 10 identifies, using attention display IDs of the plurality of attention displays, which attention display the annotation information is linked to.

In this manner, since the image capture information and the image information are associated with the image capture ID, the position information of the image capture point icon 201 is identified using the image capture ID as a key. That is, the image information associated with the image capture point icon 201 is identified. In addition, since the text information is associated with the image capture ID, the position information of the image capture point icon 201 associated with the text information is identified using the image capture ID as a key. That is, the text information associated with the image capture point icon 201 is identified.

The communication unit 13 is a communication circuit that connects the information processing device 10 to the network.

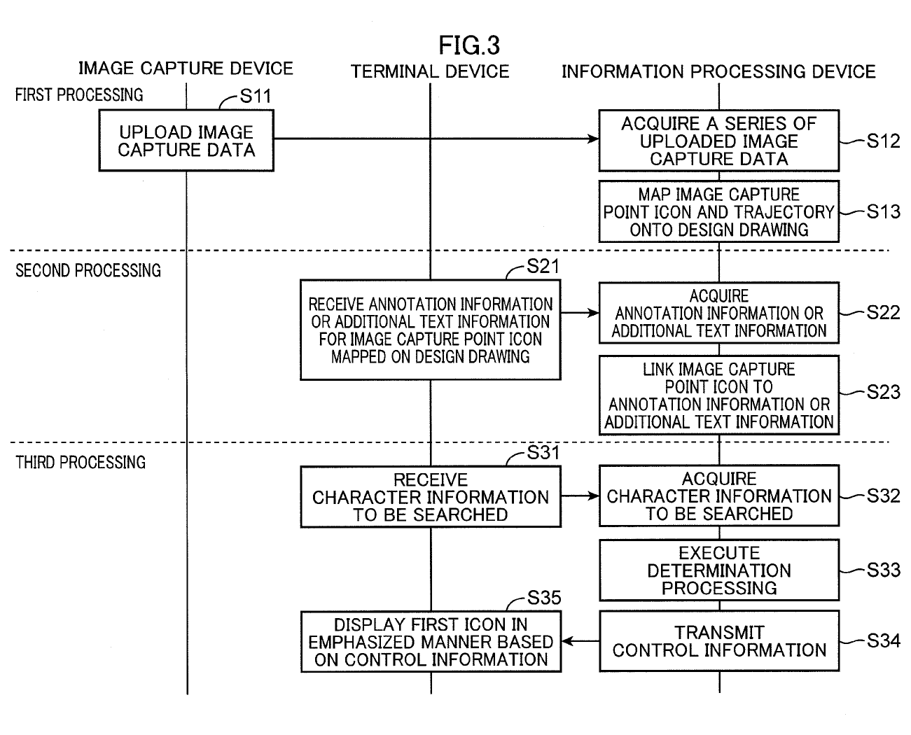

FIG. 3 is a flowchart illustrating a flow of processing executed in the information processing system 1 according to the first embodiment. As illustrated in FIG. 3, in the first embodiment, after first processing is executed, second processing is executed, and after the second processing is executed, third processing is executed. However, this is merely an example, and the order in which the processing is executed can be changed as appropriate.

In step S11 of the first processing, the image capture device 20 uploads the image capture data. In detail, in step S11, an image-capturing person performs the image capture operation. In response to this, the image capture device 20 generates a plurality of pieces of image information and image capture information corresponding to each of the plurality of pieces of image information. Then, the image capture device 20 transmits, to the information processing device 10, the plurality of pieces of image information and image capture information corresponding to each of the plurality of pieces of image information.

In step S12, the acquisition unit 111 acquires a series of uploaded image capture data. In detail, the acquisition unit 111 acquires, through the communication unit 13, the plurality of pieces of image information and the image capture information corresponding to each of the plurality of pieces of image information.

In step S13, the acquisition unit 111 maps, on the design drawing, the plurality of image capture point icons 201 and the trajectory 202. In detail, the acquisition unit 111 maps, on the design drawing, the plurality of image capture point icons 201 and the trajectory 202 using the plurality of pieces of received image information and the image capture information corresponding to each of the plurality of pieces of received image information.

In step S21 of the second processing, the terminal device 30 receives the annotation information or the additional text information for the image capture point icon 201 mapped on the design drawing. In detail, in step S21, the user selects one of the plurality of image capture point icons 201. Then, the user inputs annotation information or additional text information to be associated with the selected image capture point icon 201. The terminal device 30 that has received the annotation information or the additional text information from the user transmits the pieces of information to the information processing device 10.

In step S22, the acquisition unit 111 of the information processing device 10 acquires the annotation information or the additional text information transmitted from the terminal device 30.

In step S23, the acquisition unit 111 links (associates) the image capture point icon 201 selected by the user in step S21 with the annotation information or the additional text information.

In step S31 of the third processing, the terminal device 30 receives, from the user, character information that the user desires to search for. Furthermore, the terminal device 30 transmits, to the information processing device 10, the character information received from the user.

In step S32, the acquisition unit 111 of the information processing device 10 acquires (receives) the character information that the user desires to search for.

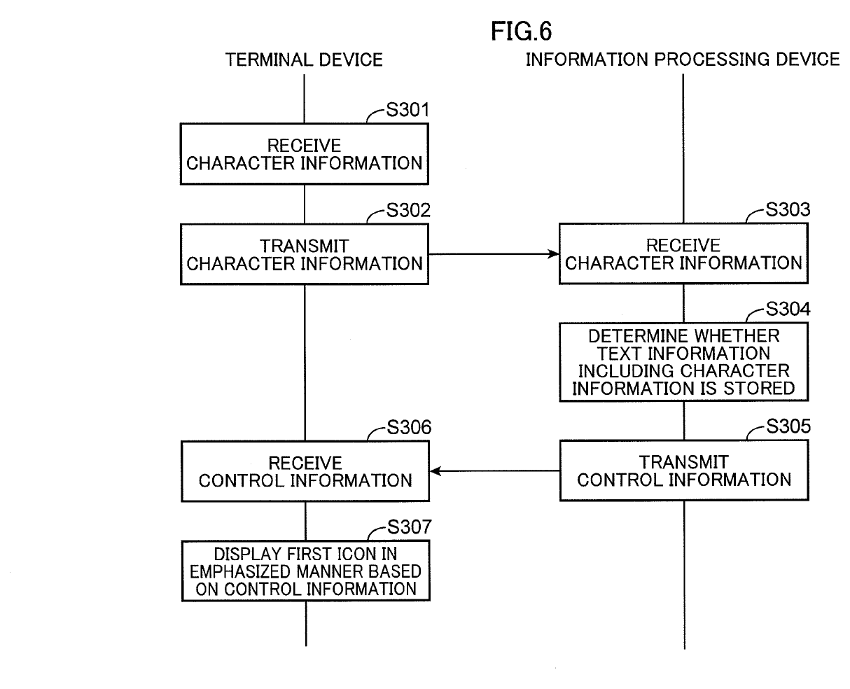

In step S33, the acquisition unit 111 executes determination processing. In step S34, the output unit 114 generates control information based on the determination result of the determination processing, and transmits the control information to the terminal device 30. In step S35, the terminal device 30 displays, based on the control information, the first icon in an emphasized manner. Details of the processing of steps S33 to S35 will be described later with reference to FIG. 6.

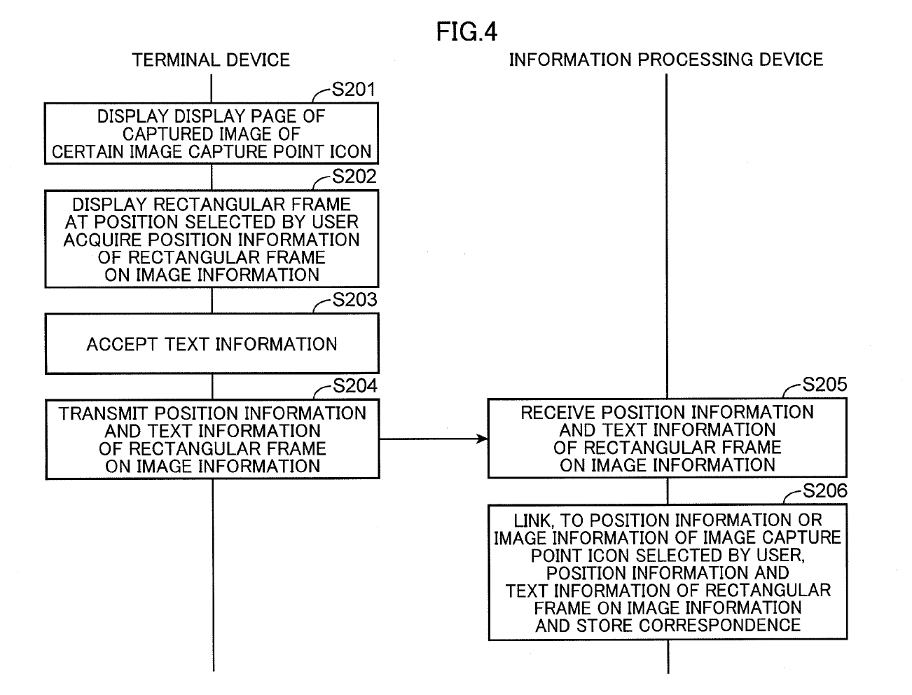

FIG. 4 is a flowchart illustrating details of the second processing (steps S21 to S23 in FIG. 3) in a case in which the annotation information is associated with the image capture point icon 201.

In step S201, the terminal device 30 displays, on the display 31, a display page including image information associated with a certain image capture point icon 201.

In detail, in step S201, the terminal device 30 receives a display instruction from the user. The terminal device 30 that has received the display instruction transmits the display instruction to the information processing device 10. The acquisition unit 111 of the information processing device 10 that has received the display instruction reads the design drawing designated by the user from the memory 12. Then, the output unit 114 of the information processing device 10 transmits, to the terminal device 30, an instruction to cause the design drawing read by the acquisition unit 111 to be displayed on the display 31. The terminal device 30 that has acquired such an instruction displays the design drawing on the display 31.

Subsequently, the terminal device 30 receives a selection instruction from the user. In detail, the user inputs, into the terminal device 30, an operation for selecting the image capture point icon 201 linked to the image information for which the user desires to input text information. The selection instruction includes position information of the image capture point icon 201 selected by the user. That is, the selection instruction includes information indicating which image capture point icon 201 has been selected among the plurality of image capture point icons 201 displayed in the design drawing. The terminal device 30 transmits the selection instruction to the acquisition unit 111. The acquisition unit 111 that has acquired the selection instruction reads, from the memory 12, the image information associated with the image capture point icon 201 selected by the user, and inputs the image information to the output unit 114. The output unit 114 transmits, to the terminal device 30, an instruction to cause the display 31 to display the image information read from the memory 12 by the acquisition unit 111. The terminal device 30 that has received such an instruction displays the image information on the display 31. That is, the terminal device 30 causes the screen of the display 31 to transition from the display page displaying the design drawing to the display page displaying the image information associated with the image capture point icon 201 selected by the user.

In step S202, the terminal device 30 displays the rectangular frame D at the position selected by the user, and acquires the position information of the rectangular frame D on the image information.

In detail, in step S202, the user inputs, into the terminal device 30, an operation of designating (selecting) a predetermined region in the image information. The operation of designating the predetermined region in the image information is, for example, a drag operation. The terminal device 30 that has received such an operation displays, in a superimposed manner on the image information, the rectangular frame D surrounding the region designated by the user. At this time, the terminal device 30 acquires position information (coordinate values) of each vertex of the rectangular frame D on the image information. That is, the position information of the attention display is acquired.

In step S203, the terminal device 30 receives the text information from the user. That is, the terminal device 30 receives the annotation information linked to the rectangular frame D illustrated in FIG. 2 and the like. For example, the terminal device 30 receives, as the annotation information, a text string such as “Carrying in from 13:00 today. We use this place” illustrated in the text information display field R3 of FIG. 2.

In step S204, the terminal device 30 transmits, to the information processing device 10, the position information (coordinate values) of the rectangular frame D on the image information and the text information (annotation information) received from the user.

In detail, the terminal device 30 transmits, to the information processing device 10, information for providing a notification that the user has designated a predetermined region on the image information and added the attention display (rectangular frame D) to the image information; the position information of the attention display on the image information; and the text information (annotation information) input by the user in association with the attention display.

In step S205, the acquisition unit 111 of the information processing device 10 receives the position information of the rectangular frame D on the image information and the text information (annotation information) received by the terminal device 30.

In step S206, the acquisition unit 111 links (associates), to the position information of the image capture point icon 201 selected by the user in step S201 or to the image information associated with the image capture point icon 201, the position information of the rectangular frame D on the image information and the text information input by the user in association with the rectangular frame D. The acquisition unit 111 stores the correspondence in the memory 12.

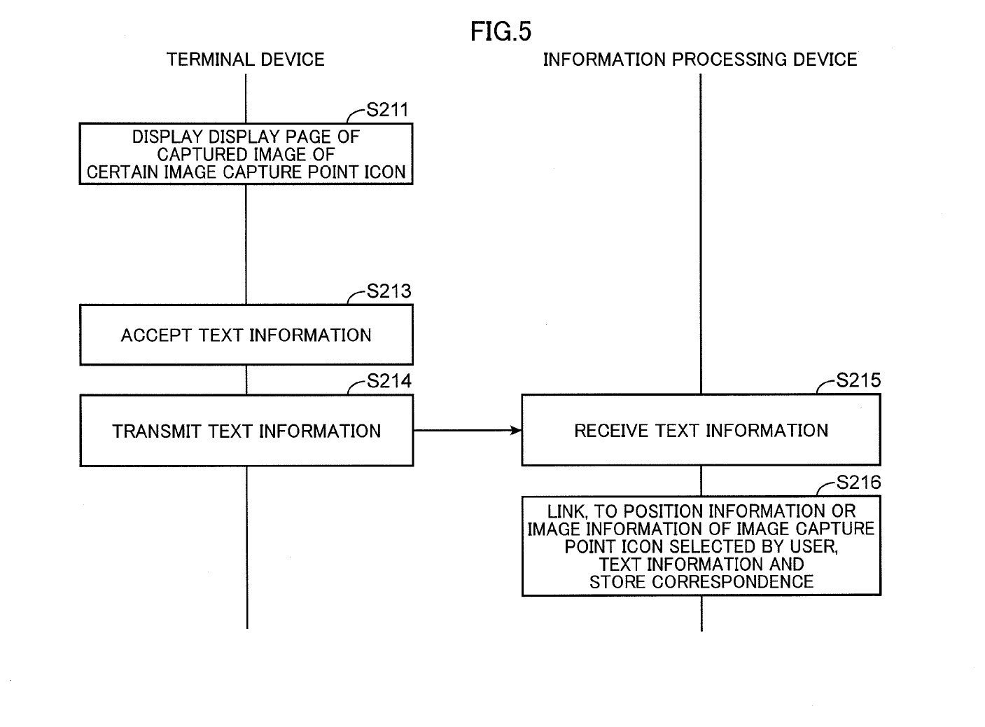

FIG. 5 is a flowchart illustrating details of the second processing in a case in which the additional text information is associated with the image capture point icon 201.

In step S211 illustrated in FIG. 5, processing similar to that in step S201 illustrated in FIG. 4 is executed.

In the flowchart illustrated in FIG. 5, the processing corresponding to step S202 illustrated in FIG. 4 is not executed.

In steps S213 to S216 illustrated in FIG. 5, processing similar to that in steps S203 to S206 illustrated in FIG. 4 is executed. However, in step S214, unlike step S204, the terminal device 30 does not transmit the position information of the rectangular frame D on the image information. In addition, in step S215, unlike step S205, the acquisition unit 111 does not receive position information of the rectangular frame D on the image information. In addition, in step S216, the acquisition unit 111 links the text information to the position information of the image capture point icon 201 selected by the user in step S211 or the image information associated with the image capture point icon 201. That is, in step S216, the processing of linking the position information of the rectangular frame D on the image information to the position information of the image capture point icon 201 selected by the user in step S211 or the image information associated with the image capture point icon 201 is not executed.

Through execution of the processing according to steps S201 to S206 of FIG. 4 and the processing according to steps S211 to S216 of FIG. 5, the text information (annotation information or additional text information) input by the user is accumulated in the text information storage unit 124 of the memory 12.

FIG. 6 is a flowchart illustrating details of the third processing illustrated in FIG. 3.

In step S301, the terminal device 30 receives character information from the user.

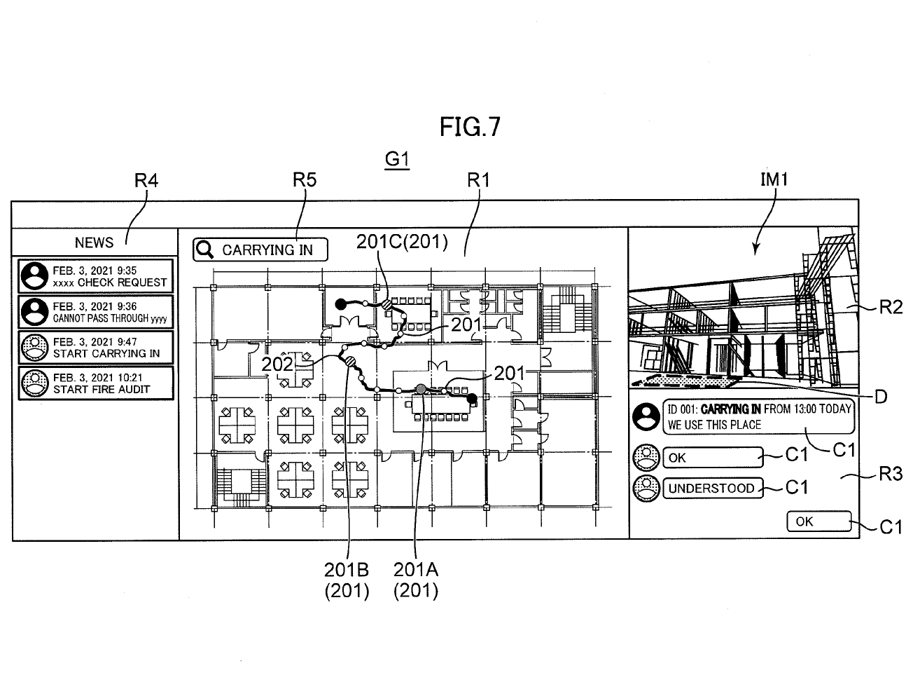

In detail, in step S301, the output unit 114 transmits, to the terminal device 30, an instruction for requesting that the display screen G1 be displayed on the display 31. The terminal device 30 that has received such an instruction displays the display screen G1 on the display 31. FIG. 7 is a diagram illustrating an example of the display screen G1 displayed in step S301. As illustrated in FIG. 7, the display screen G1 includes a search window R5. In step S301, the user inputs character information into the search window R5.

In step S302, the terminal device 30 transmits, to the information processing device 10, the character information input by the user into the search window R5.

In step S303, the acquisition unit 111 receives the character information.

In step S304, the acquisition unit 111 executes determination processing of determining whether the text information including the character information input by the user is stored in the text information storage unit 124. In detail, the acquisition unit 111 sets a search range such that all the character information accumulated in the text information storage unit 124 of the memory 12 becomes a search target, sets the character information input by the user as a keyword, and executes search processing. Accordingly, the acquisition unit 111 determines whether the text information including the text string matching the keyword exists in the text information storage unit 124. Here, when the text information including the character information input by the user is stored in the text information storage unit 124, the acquisition unit 111 identifies the image capture point icon 201 associated with the text information. That is, the acquisition unit 111 identifies the first icon. Then, the acquisition unit 111 acquires, from the memory 12, various types of information related to the first icon, such as position information of the first icon on the design drawing and image information associated with the first icon. Note that, when the acquisition unit 111 cannot identify the first icon, the processing ends.

In step S305, the output unit 114 transmits the control information to the terminal device 30. In detail, the output unit 114 generates the control information based on the result of the determination processing of the acquisition unit 111 in step S304. The control information includes an instruction to display the first icon in an emphasized manner. The output unit 114 transmits the control information to the terminal device 30.

In step S306, the terminal device 30 receives the control information.

In step S307, based on the control information, the terminal device 30 displays, on the display 31, the display screen G1 on which the first icon is displayed in an emphasized manner.

The third processing will be described in detail with reference to FIG. 7. First, the user inputs character information into the search window R5 (step S301). In the example illustrated in FIG. 7, the user inputs character information “carrying in” into the search window R5. Hereinafter, the character information input by the user into the search window R5 is referred to as a keyword. The terminal device 30 transmits the keyword to the information processing device 10 (step S302). The keyword “carrying in” input by the user is acquired by the acquisition unit 111 (step S303), and the acquisition unit 111 identifies the image capture point icon 201 associated with the character information including the keyword “carrying in”, that is, the first icon (step S304). Here, it is assumed that among the plurality of image capture point icons 201 illustrated in FIG. 7, image capture point icons 201A, 201B, and 201C are identified as the first icons. Based on the identification result of the acquisition unit 111, the output unit 114 generates control information including an instruction for requesting that the first icon be displayed in an emphasized manner (step S305). That is, the output unit 114 generates control information including an instruction for requesting that the image capture point icons 201A, 201B, and 201C be displayed in an emphasized manner on the display screen G1. The terminal device 30 that has received such control information from the output unit 114 (step S306) displays, based on the control information, the first icons in an emphasized manner (step S307).

The instruction for requesting that the first icon be displayed in an emphasized manner is, for example, an instruction to make a display mode of the first icon different from a display mode of the second icon. In this example, the image capture point icon 201 associated with the text information not including the keyword “carrying in” corresponds to the second icon. Specifically, among the plurality of image capture point icons 201 illustrated in FIG. 7, the image capture point icons 201 other than the image capture point icons 201A, 201B, and 201C correspond to the second icons.

The instruction to make the display mode of the first icon different from the display mode of the second icon is, for example, an instruction to make the color of the first icon different from the color of the second icon. In detail, the instruction is an instruction for requesting that the first icon be displayed in, for example, red and the second icon be displayed in, for example, yellow. Furthermore, the instruction to make the display mode of the first icon different from the display mode of the second icon may be an instruction for requesting that a radius of a circular image constituting the first icon be relatively larger than a radius of a circular image constituting the second icon. In addition, the instruction may be an instruction for requesting that, among the plurality of image capture point icons 201, only the first icon be displayed in the design drawing display field R1 and the second icon not be displayed (e.g., be made transparent) in the design drawing display field R1. In addition, the output unit 114 may transmit various instructions to the terminal device 30 to cause the first icon to be displayed in an emphasized manner.

Furthermore, the output unit 114 may generate an instruction for requesting that, together with the first icon displayed in an emphasized manner, image information associated with the first icon displayed in an emphasized manner be displayed in the image information display field R2. For example, the output unit 114 may generate control information including an instruction for requesting that the image capture point icon 201A (first icon) be displayed in red, the second icon be displayed in yellow, and image information associated with the image capture point icon 201A be displayed in the image information display field R2. In this way, the user can check the image information associated with the first icon, thereby improving convenience of the application.

Note that when a plurality of first icons exist, the output unit 114 selects one of the plurality of first icons. Then, the output unit 114 generates control information including an instruction to cause image information associated with the selected first icon to be displayed in the image information display field R2. For example, the output unit 114 selects, from among the plurality of first icons, the first icon having the latest image capture date and time. However, this is merely an example, and the output unit 114 may select one first icon by an appropriate method.

When selecting one of the plurality of first icons, the output unit 114 may generate control information including an instruction to make the display mode of the selected first icon different from those of the other first icons. For example, it is assumed that the output unit 114 selects the image capture point icon 201A from among the plurality of first icons. In this case, the output unit 114 may generate control information including an instruction to display the image capture point icon 201A in red, to display the image capture point icons 201B and 201C in orange, and to display the second icon in yellow.

According to the information processing system 1 described above, the first icon, which is the image capture point icon 201 associated with the text information including the character information input by the user, is displayed in an emphasized manner. In this way, the user can easily grasp the location of the first icon that is the image capture point icon 201 associated with the desired text information. As a result, an increase in the number of the processing steps of the information processing device 10 and the like is suppressed, thereby making it possible to suppress an increase in the load on the information processing device 10 and the like.

The present disclosure may adopt the following modifications.

(1) When a plurality of attention displays is associated with the image information, the control information generated by the output unit 114 may include an instruction to display, in the image information display field R2, only the attention display associated with the text information.

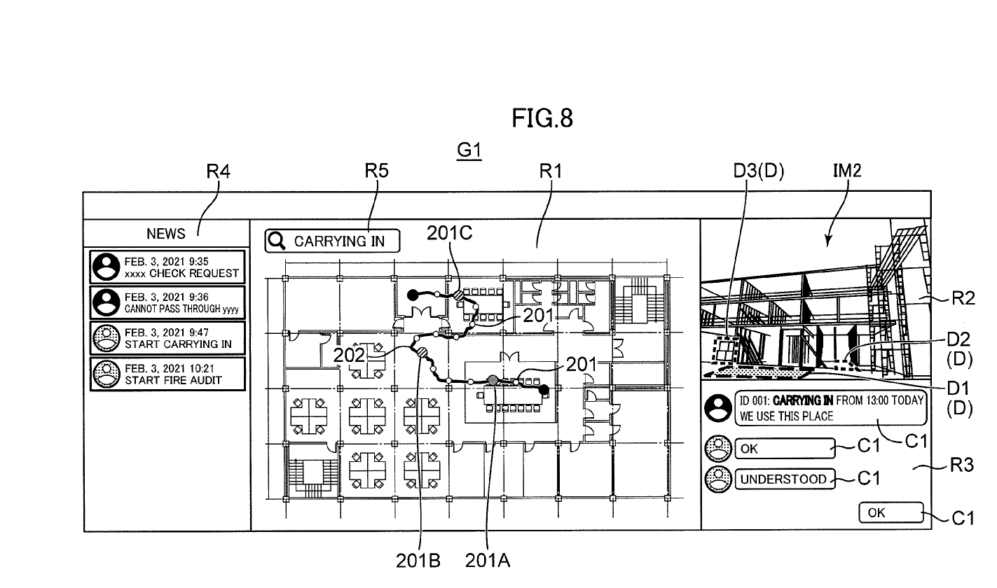

FIG. 8 is a diagram illustrating an example of the display screen G1 according to the present modification. An image information IM2 displayed in the image information display field R2 according to the present modification is associated with a plurality of attention displays. As a result, in the image information IM2, a rectangular frame D1, a rectangular frame D2, and a rectangular frame D3 are drawn. Here, it is assumed that text information (annotation information) is linked to the rectangular frame D1, and text information is not linked to the rectangular frames D2 and D3. In this case, the output unit 114 generates control information including an instruction for requesting that only the rectangular frame D1 be drawn in the image information IM2.

According to the present modification, when the plurality of attention displays is associated with the image information, it is possible to allow the user to more reliably understand which attention display the text information is associated with.

(2) When the plurality of attention displays is associated with the image information, the control information generated by the output unit 114 may include an instruction to display, in the image information display field R2, an attention display linked to text information in a mode different from a mode of an attention display not linked to text information.

A description will be given with reference to FIG. 8. Similar to the modification (1), it is assumed that text information (annotation information) is linked to the rectangular frame D1 in FIG. 8, and text information is not linked to the rectangular frames D2 and D3. In this case, the output unit 114 generates control information including an instruction to make a display mode of the rectangular frame D1 different from display modes of the rectangular frames D2 and D3. For example, the output unit 114 generates control information including an instruction to display the rectangular frame D1 in red and to display the rectangular frames D2 and D3 in pink. According to the present modification, effects similar to those of the modification (1) can be achieved.

(3) The control information generated by the output unit 114 may include an instruction to make a display mode of the image capture point icon 201 different between a case in which the text information is associated with the attention display and a case in which the text information is not associated with the attention display. That is, the control information may include an instruction to make display modes of the image capture point icons 201 different between a case in which the annotation information is associated with the image capture point icon 201 and a case in which the additional text information is associated with the image capture point icon 201, among the plurality of image capture point icons 201.

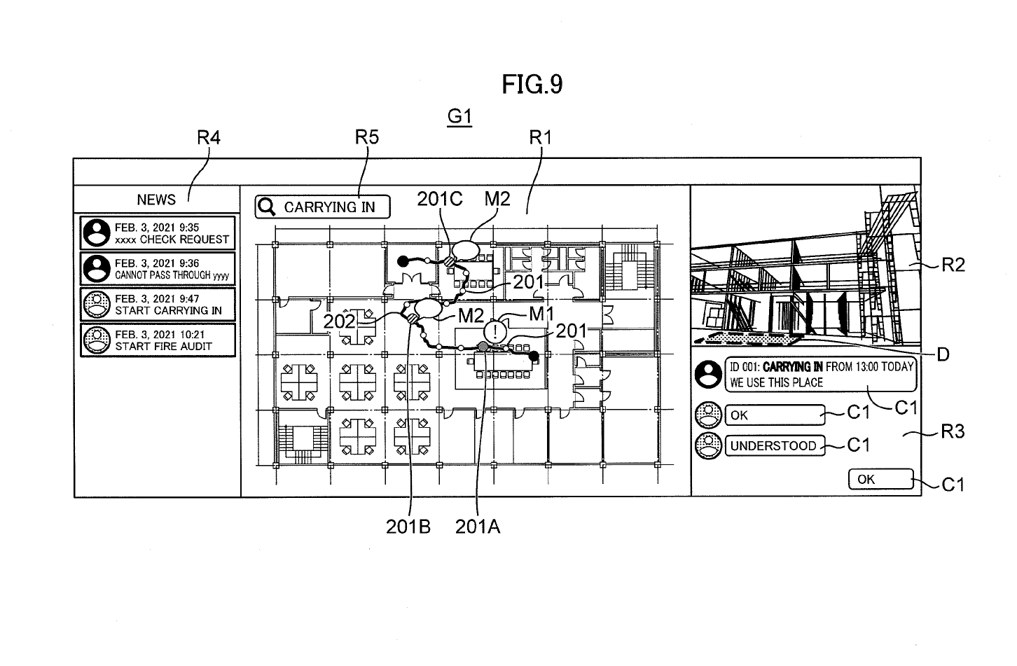

For example, the output unit 114 generates control information including an instruction for requesting that a first mark M1 be disposed around the image capture point icon 201 associated with the annotation information, and a second mark M2 be disposed around the image capture point icon 201 associated with the additional text information. FIG. 9 is a diagram illustrating an example of the display screen G1 according to the present modification. As illustrated in FIG. 9, the design drawing display field R1 of the display screen G1 includes the first mark M1 and the second mark M2, and the first mark M1 is configured by an exclamation mark and a circular image surrounding the exclamation mark. The second mark M2 is configured by an image imitating a balloon. The first mark M1 is disposed around the image capture point icon 201 associated with the annotation information. The second mark M2 is disposed around the image capture point icon 201 associated with the additional text information. Note that, when both the annotation information and the additional text information are associated with a single image capture point icon 201, the first mark M1 and the second mark M2 may be displayed around the single image capture point icon 201.

According to the configuration of the present modification, it is possible to present the image capture point icons 201 to the user in a manner that allows the user to distinguish between the image capture point icons 201 associated with the annotation information and the image capture point icons 201 associated with the additional text information.

(4) The terminal device 30 may receive, from the user, input of a narrowing-down condition for narrowing down a search range when executing the above-described search processing. For example, the terminal device 30 may receive the narrowing-down condition at a timing after receiving the keyword from the user and before transmitting the keyword to the information processing device 10. Then, the terminal device 30 may transmit the narrowing-down condition together with the keyword to the information processing device 10. In the present modification, the control information generated by the output unit 114 may include an instruction to display, in an emphasized manner, only a first icon matching the narrowing-down condition.

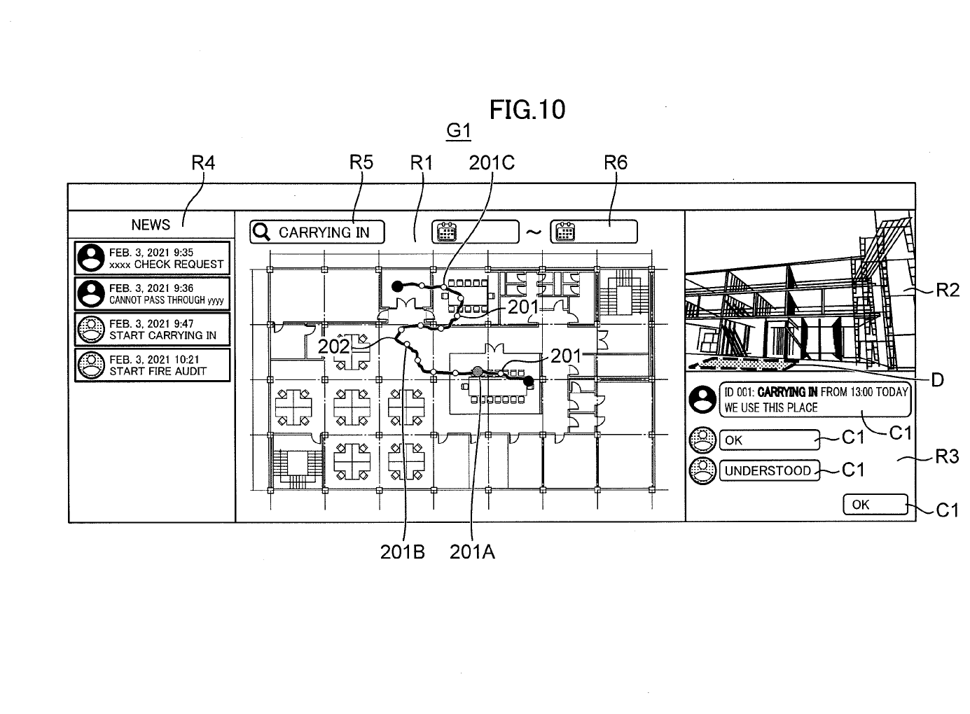

FIG. 10 is a diagram illustrating an example of the display screen G1 according to the present modification. As illustrated in FIG. 10, the display screen G1 according to the present modification includes a period input field R6. The user inputs, into the period input field R6, information designating a period. The period designated by the user is an example of a narrowing-down condition. The period input by the user is acquired by the acquisition unit 111. The acquisition unit 111 that has acquired the narrowing-down condition first identifies the first icons based on the keyword input by the user, as described in the above embodiment. Here, it is assumed that the image capture point icons 201A, 201B, and 201C are identified as the first icons. Subsequently, the acquisition unit 111 determines whether the identified first icons satisfy the narrowing-down condition. For example, it is assumed that the user inputs, into the period input field R6, a narrowing-down condition “April 1, 2024 to May 1, 2024”. In this case, the acquisition unit 111 checks the image capture date and time of the image information associated with each of the identified first icons. Here, it is assumed that the image capture date and time of the image information associated with the image capture point icon 201A is April 1, 2024, and the image capture dates and times of the image information associated with the image capture point icons 201B and 201C are March 1, 2024. In this case, the acquisition unit 111 determines that the image capture point icon 201A is a first icon that satisfies the narrowing-down condition. The acquisition unit 111 inputs this determination result to the output unit 114. The output unit 114 that has acquired the above determination result transmits, to the terminal device 30, control information including an instruction for requesting that only the image capture point icon 201A be displayed in an emphasized manner.

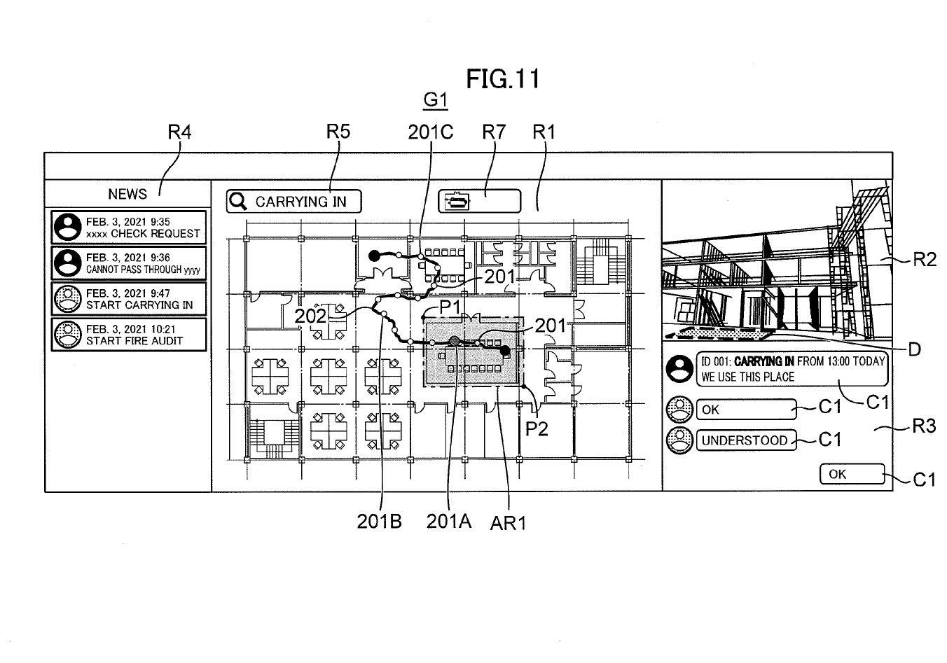

Furthermore, as the narrowing-down condition, the user may input information designating a predetermined space of the construction site (hereinafter, such information will be referred to as space designation information). FIG. 11 is a diagram illustrating another example of the display screen G1 according to the present modification. The display screen G1 illustrated in FIG. 11 includes a space designation button R7. When the user selects (e.g., clicks) the space designation button R7, the terminal device 30 switches a mode of the application from a normal mode to a space designation mode. In this state, the user inputs an operation to designate a predetermined space in the construction site. For example, the user inputs a drag operation to move a mouse cursor from point P1 toward point P2 in FIG. 11. In this case, an area AR1 illustrated in FIG. 11 is designated as a predetermined space. Then, the terminal device 30 acquires position information on the design drawing of the space designated by the user. In the example illustrated in FIG. 11, the terminal device 30 acquires coordinates of vertexes (four corners) of the area AR1.

In addition, non-illustrated buttons corresponding to spaces present in the construction site, such as “Meeting Room A”, “Meeting Room B”, “Room A”, and “Elevator Hall”, may be displayed on the display screen G1, and the user may designate a predetermined space of the construction site by selecting (clicking) one of these buttons.

The acquisition unit 111 that has received the space designation information first identifies the first icons based on the keyword input by the user, as described in the above embodiment. For example, it is assumed that the image capture point icons 201A, 201B, and 201C are identified as the first icons. Subsequently, the acquisition unit 111 determines whether the identified first icons satisfy the narrowing-down condition. That is, based on position information on the design drawing of each image capture point icon 201 and position information on the design drawing of the space designated by the user, the acquisition unit 111 determines whether the first icon is located within the space designated by the user. In the example illustrated in FIG. 11, among the image capture point icons 201A, 201B, and 201C, only the image capture point icon 201A is located within the area AR1. In this case, the acquisition unit 111 determines that the image capture point icon 201A is a first icon that satisfies the narrowing-down condition. The acquisition unit 111 inputs this determination result to the output unit 114. The output unit 114 that has acquired the above determination result transmits, to the terminal device 30, control information including an instruction to display only the image capture point icon 201A in an emphasized manner.

In addition, the output unit 114 may cause non-illustrated buttons corresponding to, for example, “first process”, “second process”, and “third process” to be displayed on the display screen G1. Then, for example, when the user selects the “first process” button, the output unit 114 may cause only first icons captured while the first process is being performed at the site to be displayed in an emphasized manner.

According to the configuration of the present modification, since only a first icon that satisfies the narrowing-down condition is displayed in an emphasized manner, the location of the first icon that satisfies a condition desired by the user can be made clear.

The present disclosure is useful for remotely checking the situation of a site.

1. An information processing method in a computer, the method comprising:
displaying a bird’s-eye view on a display of a terminal device;
displaying, in the bird’s-eye view, a plurality of image capture point icons that indicate image capture points,
each of the plurality of image capture point icons being associated with stored text information;
receiving, via a search window displayed on the display, input of a keyword from a user;
searching the stored text information associated with the plurality of image capture point icons for text information including the keyword;
identifying, based on the searching, at least one first icon from among the plurality of image capture point icons, each identified first icon being associated with text information including the keyword; and
displaying the at least one first icon in an emphasized manner by changing a display mode of the at least one first icon relative to a display mode of an icon associated with text information not including the keyword.

2. The information processing method according to claim 1, wherein
the plurality of image capture point icons are associated with image information, and
displaying the first icon in an emphasized manner includes displaying, on the display, image information associated with the first icon together with the first icon displayed in an emphasized manner.

3. The information processing method according to claim 1, wherein
displaying the first icon in an emphasized manner includes not displaying, in the bird’s-eye view, a second icon associated with text information not including the keyword among the plurality of image capture point icons.

4. The information processing method according to claim 2, wherein
the image information is associated with at least one attention display that is superimposed on the image information and displayed on the display,
the text information is associated with at least one of the at least one attention display, and
the method further comprises, when a plurality of the attention displays is associated with the image information, displaying, on the display, only the attention display associated with the text information.

5. The information processing method according to claim 2, wherein
the image information is associated with at least one attention display that is superimposed on the image information and displayed on the display,
the text information is associated with at least one of the at least one attention display, and
the method further comprises, when a plurality of the attention displays is associated with the image information, displaying, on the display, the attention display associated with the text information in a mode different from a mode of the attention display not associated with the text information.

6. The information processing method according to claim 4, wherein
displaying, in the bird’s-eye view, the plurality of image capture point icons includes making display modes of the image capture point icons different between a case in which the text information is associated with the attention display and a case in which the text information is not associated with the attention display.

7. The information processing method according to claim 1, further comprising receiving an input of a narrowing-down condition,
wherein displaying the first icon in an emphasized manner includes displaying, in an emphasized manner, only a first icon that satisfies the narrowing-down condition.

8. An information processing device comprising a processor, wherein
the processor executes:
displaying a bird’s-eye view on a display of a terminal device;
displaying, in the bird’s-eye view, a plurality of image capture point icons that indicate image capture points,
each of the plurality of image capture point icons being associated with stored text information;
receiving, via a search window displayed on the display, input of a keyword from a user;
searching the stored text information associated with the plurality of image capture point icons for text information including the keyword;
identifying, based on the searching, at least one first icon from among the plurality of image capture point icons, each identified first icon being associated with text information including the keyword; and
displaying the at least one first icon in an emphasized manner by changing a display mode of the at least one first icon relative to a display mode of an icon associated with text information not including the keyword.

9. A non-transitory computer readable recording medium storing an information processing program for causing a computer to execute:
displaying a bird’s-eye view on a display of a terminal device;
displaying, in the bird’s-eye view,
a plurality of image capture point icons that indicate image capture points, each of the plurality of image capture point icons being associated with stored text information;
receiving, via a search window displayed on the display, input of a keyword from a user;
searching the stored text information associated with the plurality of image capture point icons for text information including the keyword;
identifying, based on the searching, at least one first icon from among the plurality of image capture point icons, each identified first icon being associated with text information including the keyword; and
displaying the at least one first icon in an emphasized manner by changing a display mode of the at least one first icon relative to a display mode of an icon associated with text information not including the keyword.
